(19) United States
(12) Patent Application Publication
(10) Pub. No.: US 2016/0379525 A1
(43) Pub. Date: Dec. 29, 2016

(54) Amusement Ride Test Dummy System

(71) Applicant: Dave Berkley, Yankeetown, FL (US)

(72) Inventor: Dave Berkley, Yankeetown, FL (US)

(21) Appl. No.: 14/751,300

(22) Filed: Jun. 26, 2015

(51) Int. Cl. G09B 23/30; A63G 21/04

(52) U.S. Cl. CPC G09B 23/30; A63G 21/04

(57) ABSTRACT

A test dummy device and a system of test dummies are provided that enable quick and varied testing of amusement rides. A test dummy includes a weighted canister is surrounded by a relatively soft dummy body. The dummy body is formed of a material that prevents contact damage to the ride structures and provides accurate load transfer during test operations. A second weight is configured to be received within the canister while the test dummy is in place in test operation, to provide for a second test weight configuration. An inflatable cushion can be provided to engage a ride lap bar or similar ride structure to stabilize the test dummy during use.

### BACKGROUND

The present invention pertains to test devices used to simulate, during safety test operation, the presence of a human in or on a conventional amusement ride. As used here, an “amusement ride” and the like means a rolling coaster and any of a great variety of similar systems for amusement that support a human rider during transport or movement; such systems as are found in amusement parks, fairs, theme parks, carnivals as have been made famous by locations like Coney Island and Disney World.

Typically, amusement rides are required to be periodically tested via load test rides with weighted inanimate objects to assure safe operating parameters when the ride is loaded with live cargo. Most commonly, the test weight is provided by sand bags or “water dummies”: hollow canisters filled with water or other product to reach a desired weight.

The previously used sand bags and water dummies are bulky and difficult to handle and position into ride seats and require time to fill and unfill. As a result, a substantial number of man-hours are expended and operating hours are lost for the ride. Additionally, water leakage from water dummies (fairly common with older units) can contaminate sensitive electronics that are often located beneath ride system car bodies.

Some ride systems require testing at multiple loadings thereby requiring two or more different sets of test weights for different load and overload condition. Often, one test load is a relatively normal 175 pound load for regular testing (generally weekly) but other heavier sets may be used for overload situations in, generally, more infrequent testing.

Existing time, handling and storage limitations of amusement ride test devices result in substantial monetary expense and devaluation of amusement ride operations. What is desired is a test system that is quicker and easier to use during test operations and can provide multiple different test weights with reduced test operation time.

### SUMMARY OF THE INVENTION

The present invention is a test dummy device and a system of test dummies that enable quick and varied testing of amusement rides. A test dummy according to the invention includes a weighted canister with an enlarged bottom plate; the canister and plate being surrounded by a relatively soft dummy body that supports the plate and canister and provides a supporting surface for contacting with the associated ride in use. The dummy body is formed of a material that prevents contact damage to the ride structures and provides accurate load transfer during test operations. As well, a secondary weight is configured to be received within the canister while the test dummy is in place in test operation, to provide for a second test weight configuration. This novel configuration allows amusement ride testing with a single test dummy device at different total weights.

A system of test dummies according to the invention includes multiple similar test dummies supported by a loading frame that provides a predetermined relative placement of the test dummies to match the known configuration of a ride, for the purposes of loading the dummies, simultaneously, in the ride.

The invention includes a method of ride testing that includes supporting a multiple of test dummies according to the invention, locating all the test dummies above a multiple of ride seats, and depositing the test dummies simultaneously in the ride seats. The ride seats may be any of various different structure types configured for persons to sit on or in to be supported during operation of a conventional amusement ride.

The invention includes a test kit that includes multiple dummies, each with a set of multiple test weights to allow testing at multiple total dummy weights.

In a preferred embodiment, the dummy includes an expandable lap cushion that is configured to be inflated to expand to engage a ride lap-bar to ensure secure positioning of the dummy in the ride seat. This embodiment enables a preferred method of testing a ride that includes engaging and securing the test dummy with an associated ride bar through expanding the flexible cushion.

Other aspects of the invention will become clear from the following description of embodiments of the invention and the associated drawing figures. Other embodiments are contemplated and will be obvious to one skilled in the art, and may include devices, mechanisms and materials developed in the future that may be used for the same purpose as the elements illustrated herein to arrive at the same result.

### DESCRIPTION OF THE DRAWINGS

FIG. 1 is a perspective illustration of a test dummy according to the invention.

FIG. 2 is a side section view of the inventive test dummy located on a conventional amusement ride seat.

FIG. 3 is a detail view of the multiple weight system according to the invention, before imbedded in a dummy body.

FIG. 4 is a side view of a test dummy loading system according to the invention.

FIG. 5 is a perspective view of the test dummy loading system.

FIG. 6 is a perspective view of a test dummy kit including multiple weights for each test dummy.

FIG. 7 is a perspective view of a preferred embodiment of a test dummy including an flexible expandable cushion.

FIG. 8A is a side view of the configuration of FIG. 7.

FIG. 8B is the side view of FIG. 8A with a cushion in an inflated condition.

### DETAILS OF EMBODIMENTS OF THE INVENTION

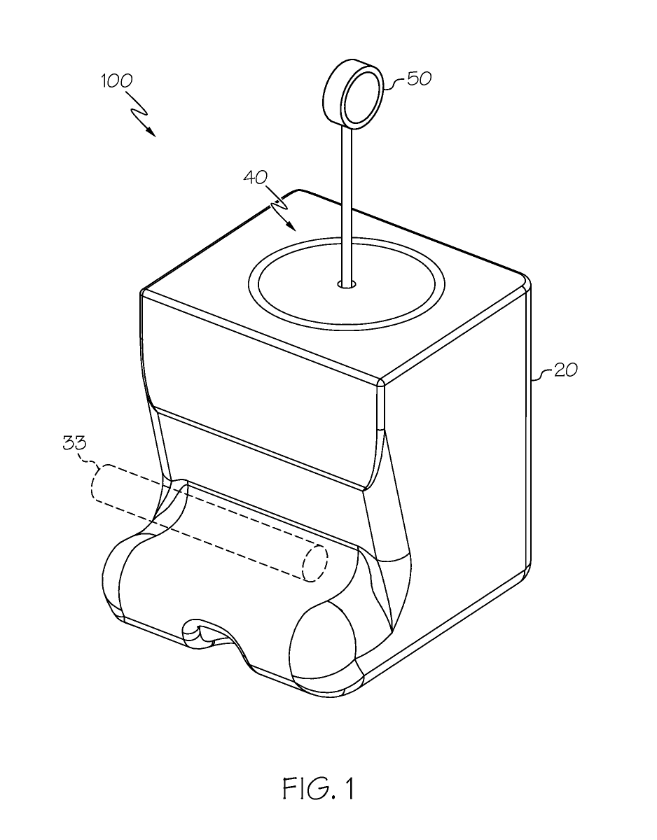

FIGS. 1 through 3 illustrate different aspects of a common embodiment of the invention. The following discussions regards these figures and embodiment.

A test dummy device 100 according to the invention includes a dummy body 20. The dummy body 20 is rigid overall and generally shaped and configured to be located and secured in an amusement ride “seat” in the manner of a human user located as intended for operation of the ride. Herein, the word “seat” is used to indicate the surface intended to support the human user.

A conventional ride seat may have support surfaces that are primarily horizontal, or vertical, or angled, or complex having horizontal, vertical and angled surface portions. Depending on the design and operation of a ride, the ride structure and seat may be required to support and resist forces generated from an accelerated human user's mass that are directed in any direction. As a result the particular shape and configuration of body 20 of a particular test dummy according to the invention may be substantially different from that illustrated. The shapes and surfaces required to contact and interact with a ride structure and seat may be altered or may have additional structures or features while maintaining the essential features and functions of the invention.

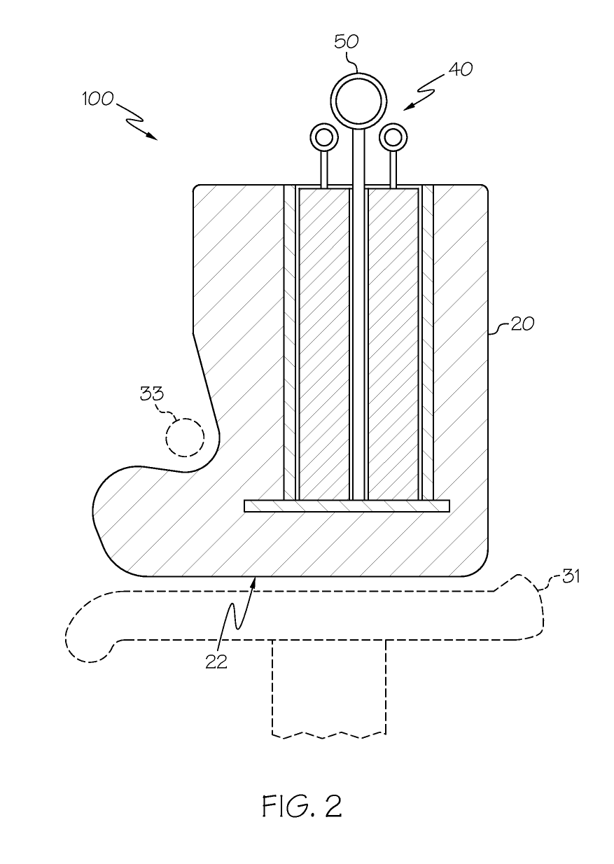

As seen in FIGS. 1 and 2, the body 20 is shaped and configured to be received on a conventional ride seat platform 31 and be retained partially by a typical conventional seat lap bar 33. In other configurations, the associated intended ride may not include a lap bar 33 and may include restraint or support structures or devices, for example, but not limited to, shoulder straps, shoulder bars, seat belts any other conventional restaints. In the configuration shown, the shape of the body 20 is designed to interact with the lap bar 33 in the same manner as would a human user during intended operation and use.

The dummy body 20 provides physical geometry and surfaces and structure enabling loading, for test purposes, the ride structures that normally interact with a human user's body and its acceleration forces during operation. To establish the needed mass, weight and center of mass location, duplicating that of a human user's body, a weight system 40 is incorporated within the test dummy device 100.

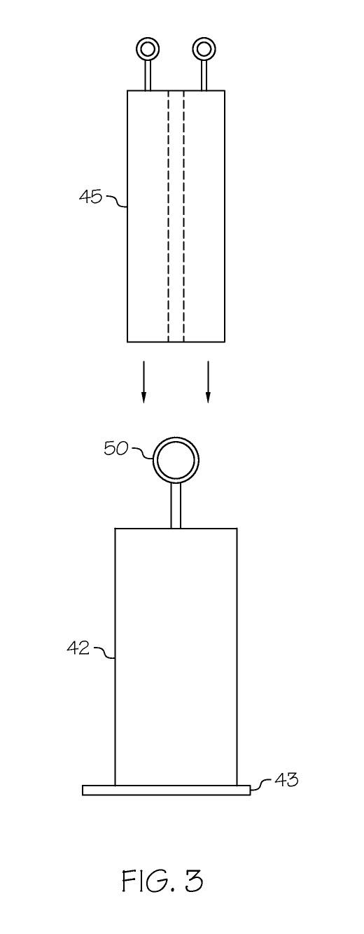

The weight system 40, illustrated in FIG. 3, includes a rigid canister 42 which is rigided connected to or integrated with a flat base 43. The purpose of both the canister 42 and base 43 is to both provide additional mass to the test device 100, and to distribute the acceleration forces generated during use to the body 20 to reduce and limit the magnitude of the resulting stresses such as to not exceed the strength of body 20 itself and to prevent distortion of the body shape during use. In all cases, the dummy configurations without added weights, and with test weights 45, should share a common center of mass, or their respective centers of mass should be spatial close, to ensure proper human body representation during testing.

The canister 42 is preferably formed of a circular length of steel having a thickness of ½ inch (0.5 in.) and an outer diameter of nine inches (9 in.) and length of 10½ inches (10.5 in.). The base 43 is preferably formed of plate steel having a thickness of ½ inches (0.5 in.) and a planar area of about 200 square inches (200 inch²). The base 43 must extend horizontally substantially beyond the perimeter of the canister 42.

The planar shape of the base 43 may be approximately square as shown but this is not critical and other shapes may be used. The function of the base 43 is to assist in supporting the weight of the body 20 when the test dummy device 100 is lifted and moved. The required area of the portions of the base 43 extending beyond the perimeter of the canister 42 is dependent in part on the weight of the body 20. Preferably, the base extends at least 1.5 inches radially outward from the canister 42 at substantially all points. The base 43 may be welded to the canister 42 or otherwise permanently attached or integrated. The canister 42 and attached base 43 are permanently integrated into the test body 20 as the body 20 is formed.

Preferably, base holes 46 are provided through the base 43, in the area outside the canister 42 to allow the molded body material to maintain sufficient continuity in this area to prevent separation of the body material from the base 43. Holes having a diameter of two inches are suggested in the corner portions of the base 43.

The body 20 is formed by a rigid yet compliant material that is strong enough to sustain the acceleration forces within. The body material properties must be strong and stiff enough to prevent distortion or failure of the body 20 after repeated uses and stiff enough to transmit, and react to, acceleration forces of the weight system 40 to the body restraints and seat structures and all other structures on which a human user's acceleration forces bear during operation of the ride. At the same time, the body material must allow complaint conformance of the body 20 to the shape and geometry of the associated ride seat during use. The body 20 includes an exterior mating surface 22 that preferably is configured to closely simulate the contact surfaces of a human user on the seat. The mating surface is also a supporting surface that functions to support and retain the test dummy device 100 in place during test operations.

The surface compliance of the body 20 is important both to prevent destruction of the aesthetic aspects and function of the seat itself, and to replicate accurately the human body acceleration forces transfer during typical operation of the ride with human riders. Preferably, the body 20 is formed of a substantially polyurethane elastomer material and most preferably a polyurethane material available under the brand name “REOFLEX” (Smooth-On Inc. of Pennsylvania, U.S.) and having a hardness in the range of 50 to 70 on the Shore A scale (Shore A; ASTM D-2240). Other materials having essentially equal hardness and strength may also be used if providing the same properties and function as described here.

The weight system 40 is designed based on a density of the body material of 64 pounds per cubic foot (64 #/cu.ft.) and the respective volume of the dummy body 20 to arrive at a desired total weight. In embodiments where the body volume is different, or the total weight for test purposes is different than that suggested here, the thickness or other dimension of the weight system elements may be modified to arrive at the desired total weight.

The combined mass and weight of the body 20 and the canister 42 and base 43 is preferably equal to a first test configuration weight. In this way, the associated ride may be operated in a first test condition while the test dummy device 100 is in place in the ride. This configuration is illustrated in FIG. 1. In one preferred configuration the total first test configuration weight is 175 pound to enable one typical conventional test configuration.

In a second test configuration, illustrated (FIG. 2), an insert weight 45 is disposed within the canister 42 to increase the total weight of the test dummy device 100. The insert weight 45 may be introduced to and retained within within the canister 42 while the test dummy device 100 is in position in the associated ride, without altering the test dummy device 100 position or configuration in anyway relative to the associate ride. In this way, the effective weight of the test dummy device 100 may be altered to arrive at a second test configuration weight. The weight of the insert weight 45 is designed to arrive at a desired total weight. In a preferred configuration the insert weight is substantially steel and has a weight of about 125 pounds.

Both the test dummy device 100 and the insert weight 45 are provided with lifting attachments for convenience. As shown in the figures a center lifting rod 50 with a lifting eye are secured to the base 43. The weight system 40 must be located to ensure that the centerline of the lifting rod 50 passes through the center of mass of the test dummy device so that the test dummy device 100 may be moved and lowered onto a surface without shifting. The lifting eye may be threadably removable to enable the insert weight 45 (with a centerbore) to be lowered into the canister 42 over the lifting rod 50. The insert weight 45 is provided with lifting lugs for convenience in handling.

The test dummy device 100 may be constructed by casting the body 20 within a female mold in which a canister 42 has been appropriately positioned. The canister must be located such that the center of mass of the finished test dummy device 100, in both test configurations, closely matches that of a human user, relative to the mating surface 22. It is important that the base 43 be sufficient spaced from the bottom aspect of the mating surface 22 to prevent elevated stresses and breakout around the base 43. It is suggested that the base 43 be spaced at least four inches vertically above the bottom most portions of the mating surface 22 for this reason.

In most applications, an amusement ride to be tested includes multiple rider locations or seats and each must be tested simultaneously through weighted operation. It is usually possible to individually locate a respective test dummy device in each location or seat for test purposes. However, using the below described system and method, multiple test dummy devices 100 may be moved and installed in one step to make the test operation quicker and easier.

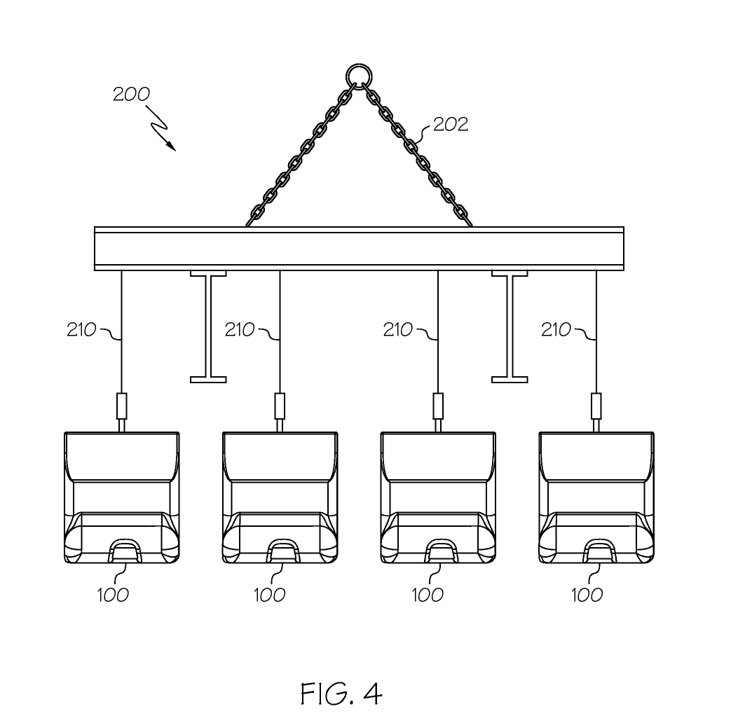

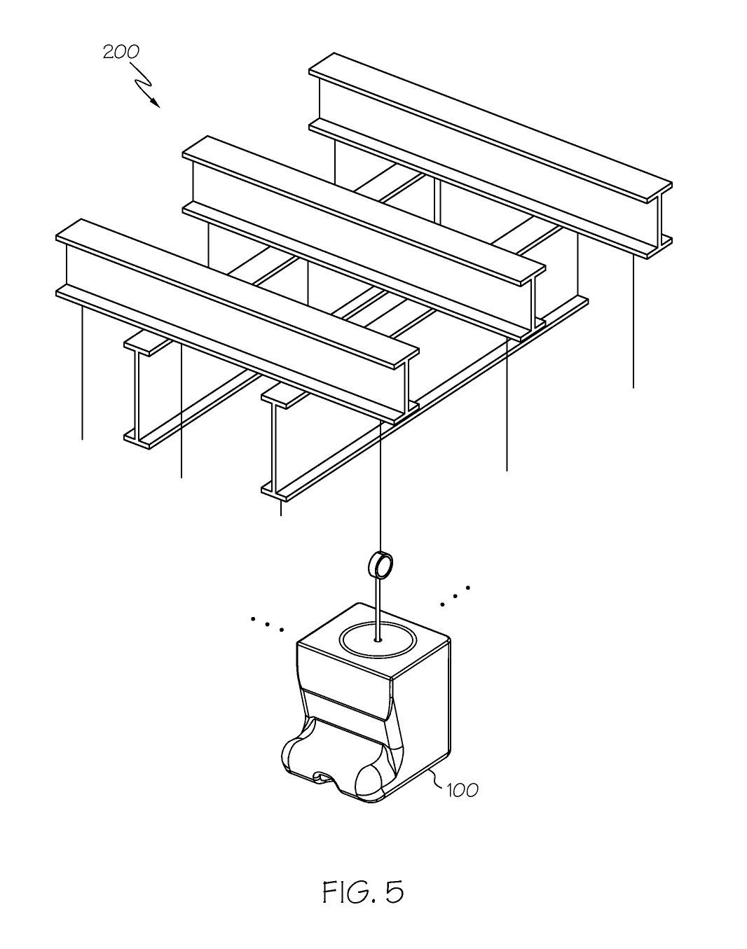

FIGS. 4 and 5 illustrate a system of support structure and multiple test dummy devices enabling simultaneously loading. In FIG. 4 a framework of beams forms a rigid support structure 200. Cables 202 or other conventional lifting means are provided to hoist and position the entire support structure 200. From the underside of the support structure 200 extend multiple test device lifting chains 210. Each lifting chain 210 is configured with a terminal end to enable attaching the lifting chain 210 to a respective test dummy device lifting rod 50. The support structure 200 and relative position of the lifting chains 210 are configured to position the multiple attached test dummy devices 100 in a horizontal array matching the seat positions of the associated ride to be loaded for testing.

It is critical that the horizontal location of the test dummy devices 100 (and hence the lifting chains 210) accurately replicate that of the ride seat positions to ensure placement of the test dummy devices 100 without relative movement between the test dummy devices 100 and the seat surfaces. For the reason function and result, rigid multiple-link chains are used entirely for the lifting chains 210, as these may be configured to prevent rotational shifting of the test dummy devices 100 and retain a certain angular position.

FIG. 5 illustrates how the support structure 200 is formed of crossed beams to enable a two-dimensional horizontal array of test dummy devices 100. The entire support structure 200, with secured test dummy devices are hoisted and positioned over a ride to allow placement of all the test dummy devices 100 at one time.

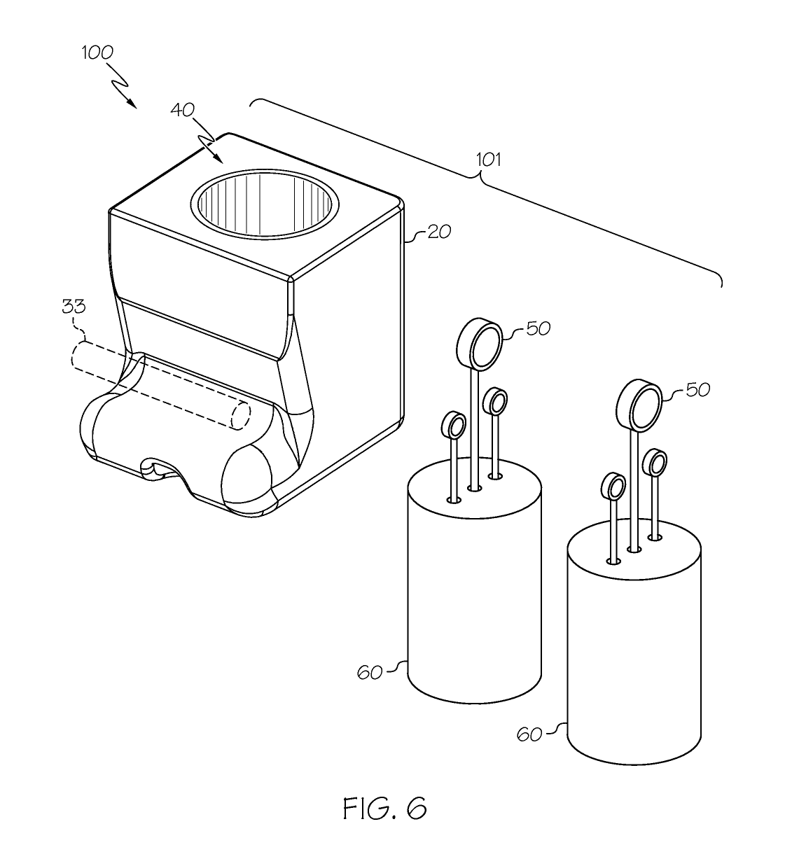

FIG. 6 is a test kit 101 including a test dummy device 100 combined with a set of multiple distinct test weights 60. Each of the set of weights 60 has a unique weight while having a common geometry to engage the test dummy device 100 such that each may be independently added to the test dummy device 100 in the manner described above. The different weights may be achieved by use of different materials or a different inside diameter so as to not alter engagement with the test dummy device, nor the respective weight center of mass. In operation, a system of test dummies is provided, each with a respective set of weights 60 to enable interchanging of the weights with each test dummy device 100.

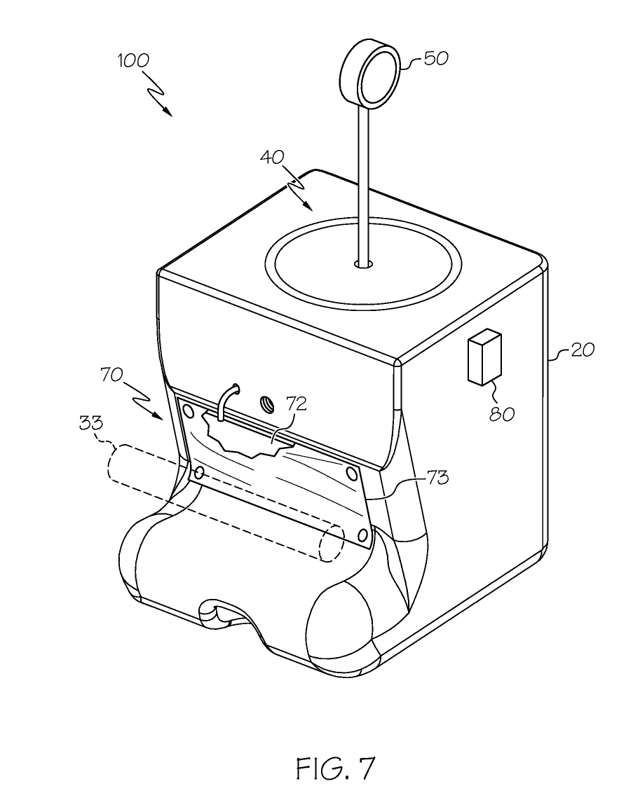

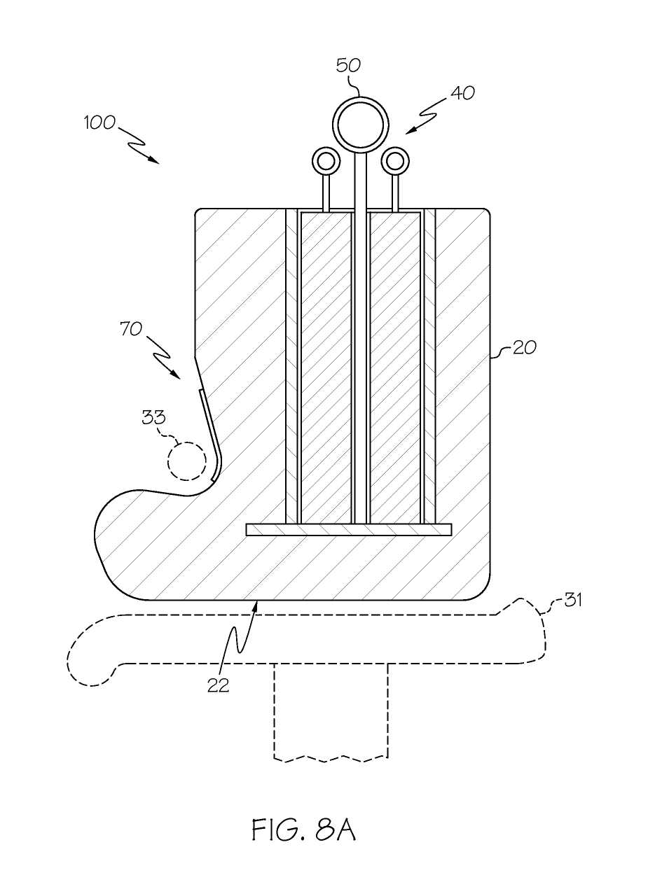

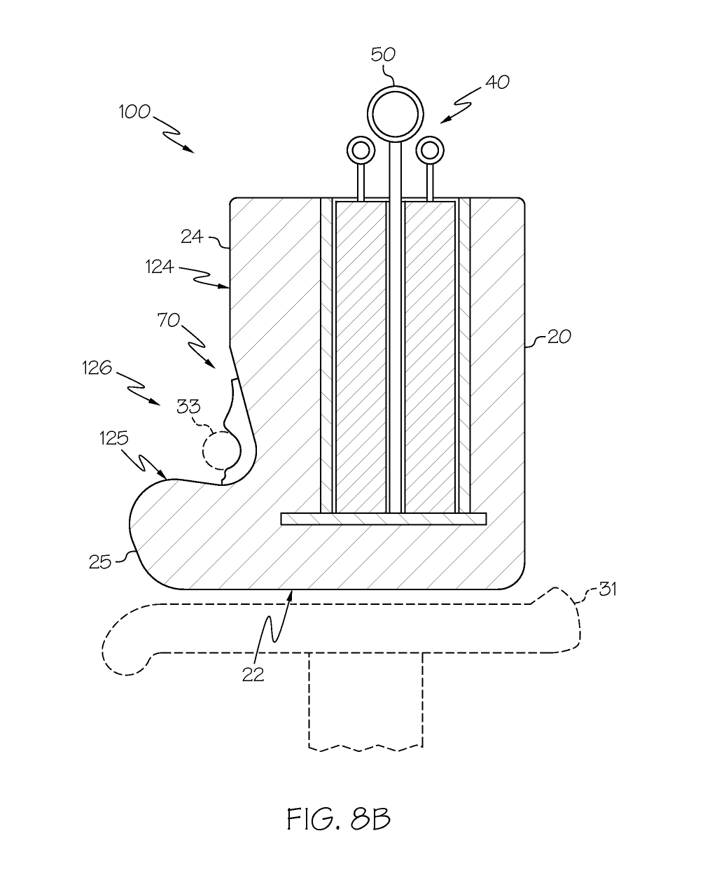

FIG. 7 is a perspective view of a preferred embodiment of a test dummy device 100 including a ride structure-engaging cushion 70. FIGS. 8A and 8B are side views of the same configuration. The function of the cushion 70 is to provide a non-rigid connection between the test dummy device 100 and a ride structural element, such as a lap bar, that is intended to constrain and retain a human rider in normal operation. Because the test dummy device 100 is rigid and the location of some constraining ride elements such as lap bars are not exact, the test dummy device 100 must be designed with some clearance between it and the lap bar, for example. This results in possible movement of the test dummy device during test operation and potentially inaccurate test results. The cushion 70 provides a means of physically engaging the dummy device 100 with the ride structure in a flexible and accommodating manner that allows for variations in ride structure geometry.

In the configuration shown, the cushion 70 includes a flexible inflatable bladder 72 and a flexible covering 73. The function of the covering 73 is to provide a convenient means of securing the bladder 72 to the test dummy device 100 while retaining the flexible nature of the bladder 72. In the configuration shown, the covering 73 is formed of sheet rubber that is secured to the test dummy by means of releasable snaps. Other means of securing the cushion 70 may be used. The bladder 72 is formed of rubber and may be constructed in conventional manner of industrial purpose air bladders. The bladder 72 must include a means of inflating and uninflating the bladder 72 with air during use, preferably manually. This may be through use of a conventional hand operated bulb, or an external air supply or hand pump (not shown).

In FIGS. 7 and 8A, the bladder 72 is uninflated and relatively collapsed against the side of the test dummy device 100. In FIG. 8B, in an inflated condition, the bladder 72 has been inflated by pumping air in to expand the bladder 72 within the covering 73 until the bladder 72 and cover 73 are stretched outward until the cushion 70 meets and contacts and engages with the ride lap bar 33. Sufficient pressure is applied by inflating the bladder 72 that the forces between the ride bar 33 and the test dummy 100, transferred by the cushion 70 stabilizes the test dummy 100 in place.

In the configuration illustrated in the figures, the test dummy body 20 includes a generally upright trunk portion 24 having a forward facing portion outer surface 124 that is generally vertical. Extending horizontally forward from the bottom of the trunk portion 24 is a leg portion 25, the upper surface 125 of which is generally horizontal. The intersection of the trunk portion 24 and leg portion 25 is a reentrant corner 126 or lap that is designed to mimic the intersection of the trunk and legs of the human body when in the body is in a naturally sitting actitude. In many conventional amusement rides, this is a natural location for a restraining “lap” bar as is illustrated by the ride lap bar 33. For most effective operation of the cushion 70, it is located at or adjacent this reentrant corner to most effectively engage an adjacent lap bar in use.

Generally, the cushion 70 should be designed to provide sufficient enlargement of dimension upon inflation to bridge a gap of up to two inches between the test dummy and the adjacent ride structure. The required bladder internal pressure for the intended purpose should be in the range of 3 to 5 pounds per square inch (3-5 psi) for most applications although this is not limiting. While in the application shown, the cushion 70 is configured and located to engage the lap bar 33, the cushion 70 may be configured and located differently to accommodate and engage other external rigid ride structures in a similar way to effect the same function and result.

In methods according to the invention, after locating a test dummy device 100 in a ride seat and positioning a retaining structure adjacent the test dummy device 100, the cushion 70 is inflated until it engages and is forced against the retaining structure. Optionally, the bladder air pressure may be measured. The applicable ride test is performed, and other completion, before removing the test dummy device 100, the cushion 70 is deflated to disengage the ride structure.

The test dummy device 100 shown in FIG. 7 includes an acceleration test device 80. The acceleration test device 80 is secured rigidly to the test dummy device 100 such that it will experience, during ride testing, the same accelerations as experienced by the test dummy device 100. The acceleration test device 80 may be located in a various points on the test dummy 100, preferably within a cavity within the test dummy device 100 for protection. Most preferably, the acceleration test device 80 is located within the test dummy device 100 according to ASTM test standard F2137, “Standard Practice for Measuring the Dynamic Characteristics of Amusement Rides and Devices”.

Preferably, the acceleration test device 80 includes accelerometers capable of detecting and measuring accelerations in three orthogonal directions. The measurement values may be stored for later retrieval or may be transmitted to a remote station. Devices for these purposes are known and available from various sources.

Other embodiments of the invention are contemplated and enabled by the above specific configurations and the associated drawings. The scope of the invention is intended to be defined by the following claims.

1. An amusement ride test device, for placement on an amusement ride seat to simulate a human rider during test operations, comprising:
a test body comprising a rigid and conformable material;
a weight receptacle integrally disposed within the test body;
a first test weight configured to be removeably received within the receptacle.

2. An amusement ride test device, according to claim 1 and further comprising:
a lifting element configured for vertical lifting and horizontal movement of the test body without rotation.

3. An amusement ride test device, according to claim 1, and wherein:
the test body comprises a polyurethane material having a hardness in the range of 50 to 70 on the Shore A scale.

4. An amusement ride test device, according to claim 1, and further comprising:
at least one added test weights, each having a mutually distinct weight and each configured to be removeably received within the receptacle.

5. An amusement ride test device, according to claim 1, and further comprising:
an inflatable cushion secured to the test body;
the cushion located on the test body such that upon inflating the cushion, the cushion may engage an adjacent ride structure.

6. An amusement ride test device, according to claim 1, and further comprising:
means for measuring and recording accelerations of the test body, such means secured to the test body.

7. An amusement ride test device, according to claim 1, and wherein:
the test body comprises a trunk portion and a leg portion, the trunk portion and leg portion intersecting to form a reentrant corner configured to accept an elongated ride bar;
the cushion located adjacent the reentrant corner and configured to engage the ride bar when the cushion is in an expanded condition.

8. An amusement ride test system comprising:
a rigid frame having a multiple lifting points, each lifting point having a hanging support for a respective test dummy device;
a multiple of test devices according to claim 2, each test device releaseably secured to a respective hanging support;
the rigid frame and lifting points configured to support and transport the multiple test devices to a multiple of ride seats, simultaneously;
such that the multiple of test devices may be placed onto the multiple ride seats and there released for test operation of the amusement ride.
